(19) United States
(12) Patent Application Publication
(10) Pub. No.: US 2023/0265877 A1
(43) Pub. Date: Aug. 24, 2023

(54) SCREW HAVING A MILLING SECTION EMBEDDED IN THE THREAD

(71) Applicant: SFS Group International AG, Heerbrugg (CH)

(72) Inventor: René Keller, Diepoldsau (CH)

(73) Assignee: SFS Group International AG, Heerbrugg (CH)

(21) Appl. No.: 18/172,584

(22) Filed: Feb. 22, 2023

(30) Foreign Application Priority Data
Feb. 23, 2022 (EP) 22158228.1

(51) Int. Cl. F16B 25/00

(52) U.S. Cl. CPC F16B 25/0063; F16B 25/0068; F16B 25/0084; F16B 25/0031

(57) ABSTRACT

A screw having the following successive functional sections: a threaded tip (150) shaped as a cone (A) having a double thread; a milling section (B) having a plurality of milling ribs (160) with outer diameter D_{F}; a cylindrical shank section having the main thread with diameter D_{N}; a thread-free shank section (D); optionally a holding thread section (E); optionally a short thread-free underhead section (F); and a head section (G) having a force engagement. The main thread (110) is guided continuously from the tip section (190) of the cone (A) via the milling section (B) to the head end of the thread-bearing shank section (C) and the ribs of the milling section (B) are arranged recessed in the thread base (140) of the continuous main thread such that the thread tips of the continuous main thread with nominal outer diameter D_{B} project beyond the milling ribs, so that D_{F}<D_{B}.

### CROSS-REFERENCE TO RELATED APPLICATIONS

This application claims priority from European Patent Application No. 22158228.1, filed Feb. 23, 2022, which is incorporated herein by reference as if fully set forth.

### TECHNICAL HELD

The present invention relates to a screw designed for fastening metal components such as trapezoidal or corrugated sheets to substructures made of wood, both in the surface and at the overlapping butt areas of sheet metal panels. It is used on facades and roofs.

### BACKGROUND

Sheet metal panels, in particular corrugated or trapezoidal sheet metal panels, are frequently used to cover facades and roofs. It is known to fasten such covering sheets or covers to a substructure made of wood, for example beams, battens or rafters, by means of screws. For economic reasons, it is desirable that these metal panels (made of aluminum, galvanized and/or painted steel sheet or similar) can be fixed directly to the substructure without pre-drilling. Therefore, a screw intended for this purpose must be able to penetrate these metal sheets on the one hand and then still anchor itself securely in the wooden substructure.

This can be achieved by using a drill screw with an integrally formed drill tip. A known accompanying problem, however, is the metallic drill chips produced when penetrating the metal sheets, because these have to be removed specifically to prevent their corrosion.

It is known to use a hardened thread tip instead of a formed drill tip, which shows a reduced tendency to chip. Bimetallic screws made of stainless steel with a welded-on tip of hardened carbon steel are also frequently used. A threaded tip means that the thread extends from the shank to the tip, where it is threaded more or less to the tip. When the screw is used, the metal of the sheet is not removed by cutting away, but displaced and deformed. The thread on the cone of the threaded tip additionally cuts a thread in the displaced metal and thus supports the advance of the screw.

### BRIEF DESCRIPTION OF THE PRIOR ART

EP 3 617 533 A1 shows a screw for fastening metal panels to wood. It has a thread that extends from the tip of the screw over the cone to the shank and is designed as a double thread in the cone area. The thread has wider flank angles on the cone than on the shank.

Furthermore, a bimetallic screw is known from DE 10 2012 215 645 with a thread which extends from the thread tip to the shank. It is designed as a sheet metal thread in the cone area and as a wood thread in the shank area.

Furthermore, the published document DE 27 32 695 teaches that it is an advantage for a self-tapping and thread-forming fastening element in metal with a thread-bearing tip if the thread height gradually decreases from the transition between shank and tip to the run-out. The thread is of multi-start design and a thread run-out extends to the tip of the thread-forming screw.

In the prior art, many individual elements of screw designs are known—bimetal design, threaded tip; double thread—which have been used in varying combinations and size (ratios) for the application purpose described. It is the object of the invention to propose a screw which is inexpensive in manufacture, efficient and, above all, simplified and safe in handling.

### SUMMARY

This object is solved by a particularly effective, user-optimized design of a generic screw that further includes one of more of the features described herein. Further variants and exemplary embodiments are provided below and in the claims.

A generic screw comprises the following functional sections which merge or adjoin one another, described from the screw tip to the screw head: A threaded tip shaped as a cone which carries a double thread, wherein this double thread comprises a main thread and a secondary thread. Adjacent to this is an essentially cylindrical milling section. Its characteristic is due to a plurality of milling ribs, which are designed as steep threads. Their outer diameter D_{F} is measured across the ribs, similar to a thread. Following this, along the longitudinal axis of the screw, there is an essentially cylindrical shank section carrying only the main thread, in which the thread outside diameter is D_{N}. Further follows a substantially cylindrical, smooth, non-threaded shank section. The screw closes with a head section with a force engagement.

The term “merging or adjoining” is used to express that the areas described can be identified structurally and/or functionally, but do not have to have a hard boundary from a -technical point of view or for technical reasons.

For example, threaded sections at the transition between two areas can be assigned to both. There may also be smooth transitions, but this does not detract from the differentiation or identification of the functional sectors mentioned. Shank section (threaded, thread-free), longitudinal section, milling section are precisely those areas of a screw that characterize a functional section.

The use of scraping edges, milling ribs or scraping grooves, as used in the functional milling section in the invention, is known. They can be oriented in various ways, e.g. arranged approximately parallel to the screw axis on the shank. As an alternative to the axis-parallel arrangement, a steep thread can also be implemented as a milling section. The steep thread can be realized clockwise (like the main thread, but with a significantly higher pitch) as well as counterclockwise.

Both concepts reduce the splitting effect of the screw when penetrating wood because the milling section locally destroys the fiber structure of the wood. This has the effect that the stresses acting on the wood through the cone are (have to be) dissipated less deeply into the material. In addition, the milled material can be more easily compacted into the recessed sections between the thread passes, which in turn also helps to reduce the necessary torque when setting the screw.

The term cone as a shape indication for the thread tip means a conical, in particular pointed-conical basic shape of the thread tip without taking into account the thread attached to it. Furthermore, the cone is not meant as the exact geometric-mathematical shape, but rather the technically realizable shape or the shape realized and identifiable as a cone in the screw.

The screw is driven, as in the prior art, via one of the many known power applications in the head section. Widely used in this application are external hexagon heads, but hexlobe, internal hexagon or comparable power applications may also be used. The screw head may provide a flat stop surface on its underside facing the shank, e.g. for use with a washer, a sealing washer or both. However, other designs are also possible depending on the application.

In one aspect, the present invention is characterized in that the main thread extends uninterruptedly and with a constant pitch from the tip section of the cone (thread tip) via the milling section to the head end of the thread-bearing shank section. The use of the term tip section instead of tip of the cone is intended to express that the tip of such a screw may vary (e.g. be deformed) in terms of manufacturing technology. Screws are generally manufactured as mass products, which means that the pointed end of the cone of a screw cannot be manufactured mathematically with perfect continuity or its shape can be changed or impaired by subsequent process steps. However, this does not detract from the functionality. In summary, the tip section refers to the technical end area of the thread tip of a few mm in length.

Furthermore, the invention is characterized in that the (milling) ribs of the milling section are arranged recessed in the thread base of the main thread passing through in such a way that the thread tips of the main thread passing through with nominal outer diameter D_{B} project beyond the milling ribs. Thus D_{F}<D_{B} applies. Here, the arrangement of the milling section on the cylindrical shank instead of on the cone results in a functional separation between the penetrating and expanding sections, i.e., the cone and the milling section. From the application profile, it is clear that the cone is to penetrate the metal sheets as chiplessly as possible and cut a thread, while the milling section is to perform its task in the wood of the substructure. This also reduces the risk of the milling section being used undesirably in the metal.

As mentioned, the main thread extends uninterrupted from the cone through the milling section into the thread-bearing cylindrical shank section. This has the advantage that the thread, which has been grooved from the thread tip into the metal of the sheet metal plates, remains continuously effective and guidance from the cone to the thread-bearing shank section is possible without interruption. This also contributes to the avoidance of metal chips.

An alternative, supplementary design of this screw provides for a holding thread section to be arranged between the thread-free shank section and the head section, followed by a short (in the sense of a few millimeters) thread-free underhead section. The holding thread section is designed as a short holding thread with 1 to 3 turns. Preferably, the holding thread is designed as a double thread. The pitch of the holding thread is greater than that of the main thread; preferably 1.6 to 1.9 times the pitch of the main thread. The flank geometry of the holding thread can also be selected asymmetrically, with the flank facing the head being of steeper design than the flank facing the thread tip. This improves the support of the drilled-through metal plate.

This addition ensures that when a drilled-through metal plate reaches the threaded underhead section, it is pulled towards the head faster than the screw as a whole sinks into the substructure due to its higher pitch. Furthermore, the thread-free underhead section creates a receiving zone for the drilled-through metal plate without the thread passing through milling or stripping the metal plate as it continues to turn. Apart from sealing problems, undesirable chip formation could otherwise occur. Thus, the metal plate is ultimately held or clamped between the head-side underhead thread run-out. The double thread design improves the quality of the support on the then double threaded run-out.

The screw is preferably designed so that the length of the thread-free underhead section and the holding thread section are each between 2 mm and 5 mm. As mentioned, the present screw can also be used to additionally accommodate a washer/seal washer in the thread-free bottom head section. The length of the section will be selected by the person skilled in the art according to the application profile.

For both described variants of the screw, the main thread is preferably symmetrically designed with a flank angle of 60°±3°. This symmetrical flank angle gives good pull-out values in wood and is also robust enough to ensure thread grooving in metal.

Further preferably, the screw according to the invention will be designed in such a way that the secondary thread starts in the tip section of the cone and its thread height continuously increases and decreases again after half the length (essentially viewed in the axial direction) of the cone and runs out in the transition area of the cone and the milling section. Running out means a non-abrupt end of the thread, which is realized by a decrease of the thread height towards zero.

In a preferred variant, the screw described here is designed so that the nominal diameter or outside diameter D_{N} of the main thread in the (thread-bearing, cylindrical) shank section is larger than the outside diameter D_{B} of the main thread in the milling section. In a preferred embodiment, the difference is six tenths of a millimeter in diameter. This also facilitates the forming of the screw.

Furthermore, it is preferred that in the screw described here the flank height from the main thread at the transition from the milling section to the cone transition, starting from the outer diameter D_{B}, steadily decreases over the tapering cone and runs out in the tip section of the cone. The reduction in thread height (with otherwise the same thread geometry) or the increase in thread height starting from the tip section reduces the resistance of the screw during penetration/forming of the metal plate and simplifies thread forming.

If it is intended to make this behavior of the flank height geometrically descriptive, this can be realized as follows: A cone is constructed, which is formed by the tangents at the thread tips of the main thread on the cone and their common intersection with the longitudinal axis of the screw. The tangents thus form an envelope over the thread tips in the shape of a cone. The common point of intersection is located in front of the technical tip of the screw, for the manufacturing reasons also mentioned above. The point angle of the conical envelope is preferably 35°±5°.

In order to better describe the geometry of the milling section, the best way is to use the (geometric) projection of a thread crest of a milling rib onto the longitudinal axis of the screw. Preferably, this projection includes a cutting angle of 30°±10°. Preferably, the pitch of this steep thread is negative, i.e. opposite to the main thread. Figuratively speaking, the milling ribs describe a steep left-hand thread in contrast to the helix of the main thread or double thread on the shank and cone.

In another preferred embodiment, the screw presented here is designed as a bimetal screw, i.e. with a stainless steel head and shank and a welded-on carbon steel tip. Thus, the cylindrical shank sections B, C, D, (and, if present, E, F) and the head section G would be made of stainless steel, and the cone of the threaded tip would be made of carbon steel. Technically, before rolling the thread, a section of carbon is welded to a stainless steel wire blank of appropriate length and then the screw is manufactured as a whole in the final form.

As is familiar to the person skilled in the art, such a screw can be provided with decorative or protective coatings if required or depending on the area of application. These include corrosion-inhibiting coatings of zinc, zinc-nickel or other metals, but also varnishes, waxes, oils and the like. It is also conceivable to apply, such coatings only to partial areas of the screw, for example a decorative head coating adapted to the sheet metal profile to be screwed.

### BRIEF DESCRIPTION OF THE DRAWINGS

FIG. 1 shows a side view of a basic version of a screw according to the invention.

FIG. 2 shows a side view of a screw according to the invention extended by additional shank sections.

FIG. 3 shows an enlarged detail of the section “Z” from FIG. 1, namely the thread tip with adjacent milling section.

FIG. 4 shows detail Y of FIG. 1 with a cross-section of the main thread.

### DETAILED DESCRIPTION

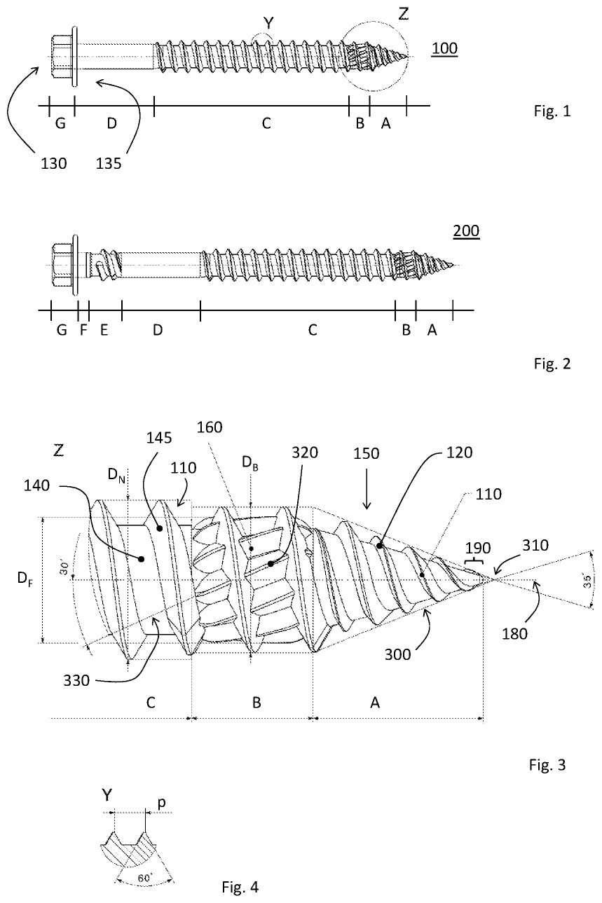

FIG. 1 shows a first embodiment of a screw 100 with the basic components G, D, C, B, A. G represents the head section with force application 130. Here, the force application 130 is shown as a hexagon in side view, which has a stop surface or stop underside 135 at its end facing the shank. This is followed, in the picture to the right or towards the tip, by a smooth, thread-free shank section D, which is cylindrical in design. The length of this section as well as of the following shank section C with the main thread is determined by the intended use and application and is therefore designed and manufactured as required. The thread-bearing shank section C passes over the milling section B, which in turn passes into the taper A. Both B and A are explained in more detail in FIG. 3.

FIG. 2 shows a variant 200 of the screw according to the invention, in which two further functional areas are inserted between the head section G and the thread-free shank section D. Adjacent to the head section G is a short thread-free underhead section F, followed in the direction of the tip by a support thread section or holding thread section E. The latter advantageously deviates from the thread geometry of the main thread.

A realization of the screw according to the invention as shown in FIG. 2 has a nominal diameter D_{N} of 6.4 mm. It is manufactured in various lengths. In a typical example, the screw has an effective length (sections A to and including F) of 150 mm, the stainless steel portion of which is 132 mm. Sections D, E and F have a combined length of approximately 74 mm. For all screws of the same diameter, the length of the carbon steel section is approximately 18 mm. For all screws of this diameter, the length of section A is about 7 mm, of section B about 4 mm. This means that an approximately 7 mm long section of the shank section C, which is provided with the main thread, is also made of carbon steel before it is continued in stainless steel. For the above-mentioned screw, a pitch of the main thread of p=2.5 mm is provided, which applies to all sections A-C. The outer diameter in section B D_{N} is approximately 5.8 mm.

FIG. 3 shows in detail an embodiment of the front section Z (detail from FIG. 1) of a screw according to the invention, for FIG. 1 as well as FIG. 2. In the drawing (from left to right), arranged along the longitudinal axis 180, a cut shank section C with man thread 110 is shown, followed by a milling section B, which merges into a cone A with thread tip 150. The main thread consists of a thread train with a flank angle of 60° and a pitch p (pitch) which, as usual, is given in mm per turn. FIG. 4 corresponds to the outline Y of FIG. 1 and shows a section of the main thread 110 in section C with the flank angle and pitch p indicated.

FIG. 3 shows an example of a thread on the shank section C with a thread base 140 and a thread flank 145. The nominal diameter of this screw D_{N} is measured across the thread tips of the main thread 110 and is drawn in FIG. 3.

The shank section C, while retaining the pitch and flank angle, merges into the milling section B with a slightly reduced thread height D_{B} of the main thread 110. There are two reasons for this reduction: Since the screw is manufactured by cold forming from a cylindrical blank, only the locally available base material is available for any thread forming. Although thickening can be achieved by upsetting, e.g. in the area of the head section G, this would be very costly in the middle of the shank area and would complicate thread rolling. After the milling ribs 160 are arranged in the milling section B in the thread base, less material is available for the main thread. Although it would be possible to achieve the same thread height in section B as in section C by reducing the flank angle of the main thread 110, this would compromise the stability of the main thread in the milling section in particular.

One of the inventive features, however, is the continuous passage of the main thread and the resulting seamless guidance of the screw from the displaced, grooved metal into the wood. Therefore, it is advantageous to reduce the thread height in the milling section B rather than the flank angle. Since during the setting process of the screw after passing the cone A through the metal plate(s), the screw temporarily has a maximum external (thread) diameter D_{B}, this means that the main thread nevertheless grips snugly in the self-furrowed channel. At the same time, when the milling section B acts in the wood, the deformation resistance of the screw is lower because of the smaller outer diameter D_{B}<D_{N}, considering the portion of the main thread alone. As tests showed, the guidance of the screw in the grooved metal section is not affected; on the contrary, the thread tips of the main thread act as spacer elements keeping the milling ribs away from the hole edges. At the transition from section B to C, the hole or thread diameter grooved in the metal plate is widened to D_{N}, but then the milling section B has already passed the metal plate(s).

FIG. 3 shows the milling ribs 160 arranged so that the milling ribs form essentially a steep left-hand thread, which increases the milling effect in the wood. The line with reference mark 330 marks the projection of the thread crest 320 onto the longitudinal screw axis 180. The drawing also shows the angle of intersection with the longitudinal screw axis 180.

In the area of the cone, it is shown how the main thread 110, while maintaining the pitch and the flank angle, slowly decreases from the diameter D_{B} at the transition area of section B to A continuously to zero and tapers off in the tip section 190. Also marked is the secondary thread 120, which, starting in the tip section, continuously increases like the main thread and tapers off again at the transition area A to B. This achieves the double thread on the thread tip on the cone A, which is advantageous for forming in the metal. The tangents on the thread crests of the main thread with a common intersection 310 form the envelope 300, with the intersection 310 being on the longitudinal axis 180 of the screw 100 or 200.

1. A screw, comprising:
functional sections that merge or are adjacent to each other as follows:
a) a threaded tip shaped as a cone having a double thread, the double thread comprising a main thread and a secondary thread;
b) a substantially cylindrical milling section having a plurality of milling ribs formed as a steep thread and having an outside diameter D_{F} measured across the ribs;
c) a substantially cylindrical shank section carrying only the main thread which has a thread outside diameter D_{N} on the substantially cylindrical shank section;
d) a substantially cylindrical, smooth, thread-free shank section;
e) a head section with a force engagement;
f) the main thread extends continuously and with a constant pitch from the tip section of the cone through the milling section to a head end of the thread-bearing shank section; and
g) the ribs of the milling section are arranged recessed in a thread base of the continuous main thread such that thread tips of the continuous main thread with a nominal outer diameter D_{B} in the substantially cylindrical milling section project beyond the milling ribs with D_{F}<D_{B}.

2. The screw according to claim 1, further comprising a holding thread section arranged between the thread-free shank section and the head section, and the holding thread section is configured as a short holding thread with 1 to 3 turns followed by a short thread-free underhead section.

3. The screw according to claim 2, wherein the holding thread comprises a double thread and a pitch of the holding thread corresponds to 1.6 to 1.9 times the constant pitch of the main thread.

4. The screw according to claim 2, wherein a length of the thread-free underhead section and the holding thread section is between 2 and 5 mm, respectively.

5. The screw according to claim 1, wherein the main thread is configured symmetrically with a flank angle of 60°±3°.

6. The screw according to claim 1, wherein the secondary thread starts in the tip section of the cone, and has a thread height that increases continuously and decreases again after half a length of the cone and runs out in a transition area of the cone and the milling section.

7. The screw according to claim 1, wherein the outer diameter D_{N} of the main thread in the shank section is larger than the outer diameter D_{B} of the main thread in the substantially cylindrical milling section.

8. The screw according to claim 1, wherein a flank height of the main thread at a transition of milling section to the cone, starting from the outer diameter D_{B}, continuously decreases over the cone as the cone tapers and runs out in the tip section of the cone.

9. The screw according to claim 1, wherein an apex angle of a conical envelope formed by tangents at thread tips of the main thread on the cone, which form a common intersection with a longitudinal axis of the screw, is 35°±5°.

10. The screw according to claim 1, wherein a projection of a respective thread crest of a milling rib onto a longitudinal axis of the screw forms an angle of 30°±10° herewith.

11. The screw according to claim 1, wherein the screw comprises a bimetal screw, and substantially cylindrical, smooth, thread-free shank section, the substantially cylindrical shank section and the head section are formed of stainless steel, and the cone and the substantially cylindrical milling section of the threaded tip are formed of carbon steel and a transition point between the stainless steel and the carbon steel is located in the substantially cylindrical shank section carrying the main thread.
